(19) United States
(12) Patent Application Publication
(10) Pub. No.: US 2019/0164237 A1
(43) Pub. Date: May 30, 2019

(54) BEVERAGE DISPENSER CONTROLS

(71) Applicant: The Coca-Cola Company, Atlanta, GA (US)

(72) Inventors: David R. NEWMAN, Atlanta, GA (US); Charles Bradley GREEN, Atlanta, GA (US)

(21) Appl. No.: 16/098,980

(22) PCT Filed: May 4, 2017
(86) PCT No.: PCT/US2017/031094

§ 371 Date: Nov. 5, 2018

Related U.S. Application Data
(60) Provisional application No. 62/332,200, filed on May 5, 2016.

(51) Int. Cl. G06Q 50/12; G06Q 20/18; G07F 13/06

(52) U.S. Cl. CPC G06Q 50/12; G06Q 20/40145; G07F 13/065; G06Q 20/18

(57) ABSTRACT

A beverage dispensing system and method include a beverage dispensing device that has a processor and a memory accessible to the processor. The memory stores instructions that when executed by the processor implement a method that includes receiving a beverage selection, and comparing the beverage selection to predefined controls. The selected beverage is dispensed in response to the comparison.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATION(S)

This application is being filed on May 4, 2017, and claims the benefit of priority to U.S. Provisional Application Ser. No. 62/332,200 filed on May 5, 2016, the entirety of which is hereby incorporated by reference.

### BACKGROUND

Various beverages are available to consumers through a wide variety of dispensing devices, such as commercial vending machines. Well known beverage vending machines allow users to select desired beverages that are packaged in bottles or cans. Other beverage dispensers include a plurality of dispensing valves that provide a corresponding plurality of beverage selections, where each dispensing valve is connected to a respective beverage source. Some beverage dispensing machines include functionality for consumers to select from a menu of available products through the use of a user interface provided on the dispensing machine itself or through a remote user interface, such as a smart phone application. Some machines further allow consumers to create custom beverages. Based on the user's beverage selection, various beverage ingredients are dispensed in desired ratios and mixed together as they flow through a dispensing valve.

### SUMMARY

In accordance with aspects of the present disclosure, a beverage dispensing system and method include a beverage dispensing device that has a processor and a memory accessible to the processor. The memory stores instructions that when executed by the processor implement a method that includes receiving a beverage selection, and comparing the beverage selection to predefined controls. The predefined controls may be stored in a user profile. The selected beverage is dispensed in response to the comparison. Thus, if the selected beverage is in accordance with the predefined controls, the dispensing device dispenses the beverage. If the selection is not in accordance with the predefined controls, the beverage is not dispensed, and an error message may be displayed for the user.

### BRIEF DESCRIPTION OF THE DRAWINGS

FIG. 1 is a block diagram illustrating an example beverage dispensing system in accordance with aspects of the present disclosure.

FIG. 2 is a block diagram illustrating further aspects of the system shown in FIG. 1 in accordance with embodiments disclosed herein.

FIG. 3 is a block diagram illustrating further aspects of the system shown in FIG. 1 in accordance with embodiments disclosed herein.

FIG. 4 is a block diagram illustrating further aspects of the system shown in FIG. 1 in accordance with embodiments disclosed herein.

FIG. 5 is a block diagram illustrating further aspects of the system shown in FIG. 4, including an example of a computing system.

FIG. 6 is a flow diagram illustrating an example of a beverage dispensing method in accordance with aspects of the present disclosure.

FIG. 7 is a flow diagram illustrating an example of a method for creating user beverage profiles in accordance with aspects of the present disclosure.

FIG. 8 is a flow diagram illustrating another example of a method for creating user beverage profiles in accordance with aspects of the present disclosure.

FIG. 9 is a flow diagram illustrating another example of a beverage dispensing method in accordance with aspects of the present disclosure.

FIG. 10 is a flow diagram illustrating an example of a method for editing user beverage profiles in accordance with aspects of the present disclosure.

FIGS. 11-15 are screen shots illustrating example user interface screens in accordance with aspects of the present disclosure.

FIG. 16 is a flow diagram illustrating another example of a beverage dispensing method in accordance with aspects of the present disclosure.

FIG. 17 is a flow diagram illustrating another example of a beverage dispensing method in accordance with aspects of the present disclosure.

FIG. 18 is a flow diagram illustrating another example of a beverage dispensing method in accordance with aspects of the present disclosure.

FIGS. 19 and 20 are block diagrams illustrating examples of system arrangements suitable for implementing the method shown in FIG. 18.

FIG. 21 is an example environmental diagram showing an interaction between a customer and a point of sale system.

FIG. 22 illustrates an example interactive display of the point of sale system of FIG. 21.

FIG. 23 illustrates an example interaction between another customer and a dispenser.

FIG. 24 illustrates example user interfaces of the dispenser of FIG. 23.

FIG. 25 is another example environmental diagram showing an interaction between customers and a point of sale system.

FIG. 26 illustrates an example user interface of the point of sale system of FIG. 21.

FIG. 27 illustrates another example user interface of the point of sale or dispenser of FIG. 21.

FIG. 28 illustrates another example user interface of the point of sale system of FIG. 21.

FIG. 29 illustrates an example interaction between the customer of FIG. 28 and a dispenser.

FIG. 30 illustrates a further example interface between the customer of FIG. 29 and the dispenser.

### DETAILED DESCRIPTION

In general, the following detailed description is directed to product dispenser systems such as beverage dispenser systems for mixing and dispensing beverages. Reference is made to the accompanying drawings, which form a part hereof, and in which is shown by way of illustration specific examples in which the invention may be practiced. It is to be understood that other examples may be utilized and structural or logical changes may be made without departing from the scope of the present invention. The following detailed description, therefore, is not to be taken in a limiting sense.

It should be understood that “beverage,” as used herein, includes, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives).

The example systems and methods described herein can control a macro-ingredient flow in the beverage dispensing system (such as a Coca-Cola® Freestyle®, legacy dispenser or legacy plus touchscreen unit). For example, a beverage dispensing system (which may include one or more macro-ingredients and one or more micro-ingredients) combines macro-ingredients (such as carbonated water) and micro-ingredients such as flavorings) to create a blended beverage. Such micro-dosing functionality may increase the dispensing capabilities of the beverage dispensing system to deliver blended beverages and improve the quality of the beverage dispensed by the beverage dispensing system.

Generally described, the macro-ingredients may have reconstitution ratios in the range from full strength (no dilution) to about six (6) to one (1) (but generally less than about ten (10) to one (1)). As used herein, the reconstitution ratio refers to the ratio of diluent (e.g., water or carbonated water) to beverage ingredient. Therefore, a macro-ingredient with a 5:1 reconstitution ratio refers to a macro-ingredient that is to be dispensed and mixed with five parts diluent for every part of the macro-ingredient in the finished beverage. Many macro-ingredients may have reconstitution ratios in the range of about 3:1 to 5.5:1, including 4.5:1, 4.75:1, 5:1, 5.25:1, 5.5:1, and 8:1 reconstitution ratios.

The macro-ingredients may include sweeteners such as sugar syrup, HFCS (“High Fructose Corn Syrup”), FIS (“Fully Inverted Sugar”), MIS (“Medium Inverted Sugar”), mid-calorie sweeteners comprised of nutritive and non-nutritive or high intensity sweetener blends, and other such nutritive sweeteners that are difficult to pump and accurately meter at concentrations greater than about 10:1—particularly after having been cooled to standard beverage dispensing temperatures of around 35-45° F. An erithritol sweetener may also be considered a macro-ingredient sweetener when used as the primary sweetener source for a beverage, though typically erythritol will be blended with other sweetener sources and used in solutions with higher reconstitution ratios such that it may be considered a micro-ingredient as described below.

The macro-ingredients may also include traditional BIB (“bag-in-box”) flavored syrups (e.g., COCA-COLA bag-in-box syrup) which contains all of a finished beverage's sweetener, flavors, and acids that when dispensed is to be mixed with a diluent source such as plain or carbonated water in ratios of around 3:1 to 6:1 of diluent to the syrup. Other typical macro-ingredients may include concentrated extracts, purees, juice concentrates, dairy products, soy concentrates, and rice concentrates.

The macro-ingredient may also include macro-ingredient base products. Such macro-ingredient base products may include the sweetener as well as some common flavorings, acids, and other common components of a plurality of different finished beverages. However, one or more additional beverage ingredients (either micro-ingredients or macro-ingredients as described herein) other than the diluent are to be dispensed and mix with the macro-ingredient base product to produce a particular finished beverage. In other words, the macro-ingredient base product may be dispensed and mixed with a first micro-ingredient non-sweetener flavor component to produce a first finished beverage. The same macro-ingredient base product may be dispense and mixed with a second micro-ingredient non-sweetener flavor component to produce a second finished beverage.

The macro-ingredients described above may be stored in a conventional bag-in-box container in, at and/or remote from the dispenser. The viscosity of the macro-ingredients may range from about 1 to about 10,000 centipoise and generally over 100 centipoises or so when chilled. Other types of macro-ingredients may be used herein.

The micro-ingredients may have reconstitution ratios ranging from about ten (10) to one (1) and higher. Specifically, many micro-ingredients may have reconstitution ratios in the range of about 20:1, to 50:1, to 100:1, to 300:1, or higher. The viscosities of the micro-ingredients typically range from about one (1) to about six (6) centipoise or so, but may vary from this range. In some instances, the viscosities of the micro-ingredients may be forty (40) centipoise or less. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutraceuticals; and over the counter (or otherwise) medicines such as pseudoephedrine, acetaminophen; and similar types of ingredients. Various acids may be used in micro-ingredients including food acid concentrates such as phosphoric acid, citric acid, malic acid, or any other such common food acids. Various types of alcohols may be used as either macro- or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

Typically, micro-ingredients for a finished beverage product include separately stored non-sweetener beverage component concentrates that constitute the flavor components of the finished beverage. Non-sweetener beverage component concentrates do not act as a primary sweetener source for the finished beverage and do not contain added sweeteners, though some non-sweetener beverage component concentrates may have sweet tasting flavor components or flavor components that are perceived as sweet in them. These non-sweetener beverage component concentrates may include the food acid concentrate and food acid-degradable (or non-acid) concentrate components of the flavor, such as described in commonly owned U.S. patent application Ser. No. 11/276,553, entitled “Methods and Apparatus for Making Compositions Comprising and Acid and Acid Degradable Component and/or Compositions Comprising a Plurality of Selectable Components,” which is herein incorporated by reference in its entirety. As noted above, micro-ingredients may have reconstitution ratios ranging from about ten (10) to one (1) and higher, where the micro-ingredients for the separately stored non-sweetener beverage component concentrates that constitute the flavor components of the finished beverage typically have reconstitution ratios ranging from 50:1, 75:1, 100:1, 150:1, 300:1, or higher.

For example, the non-sweetener flavor components of a cola finished beverage may be provided from separately stored first non-sweetener beverage component concentrate and a second non-sweetener beverage component concentrate. The first non-sweetener beverage component concentrate may comprise the food acid concentrate components of the cola finished beverage, such as phosphoric acid. The second non-sweetener beverage component concentrate may comprise the food acid-degradable concentrate components of the cola finished beverage, such as flavor oils that would react with and impact the taste and shelf life of a non-sweetener beverage component concentrate were they to be stored with the phosphoric acid or other food acid concentrate components separately stored in the first non-sweetener component concentrate. While the second non-sweetener beverage component concentrate does not include the food acid concentrate components of the first non-sweetener beverage component concentrate (e.g., phosphoric acid), the second non-sweetener beverage component concentrate may still be a high-acid beverage component solution (e.g., pH less than 4.6).

A finished beverage may have a plurality of non-sweetener concentrate components of the flavor other than the acid concentrate component of the finished beverage. For example, the non-sweetener flavor components of a cherry cola finished beverage may be provided from the separately stored non-sweetener beverage component concentrates described in the above example as well as a cherry non-sweetener component concentrate. The cherry non-sweetener component concentrate may be dispensed in an amount consistent with a recipe for the cherry cola finished beverage. Such a recipe may have more, less, or the same amount of the cherry non-sweetener component concentrate than other recipes for other finished beverages that include the cherry non-sweetener component concentrate. For example, the amount of cherry specified in the recipe for a cherry cola finished beverage may be more than the amount of cherry specified in the recipe for a cherry lemon-lime finished beverage to provide an optimal taste profile for each of the finished beverage versions. Such recipe-based flavor versions of finished beverages are to be contrasted with the addition of flavor additives or flavor shots as described below.

Other typical micro-ingredients for a finished beverage product may include micro-ingredient sweeteners. Micro-ingredient sweeteners may include high intensity sweeteners such as aspartame, Ace-K, steviol glycosides (e.g., Reb A, Reb M), sucralose, saccharin, or combinations thereof. Micro-ingredient sweeteners may also include erythritol when dispensed in combination with one or more other sweetener sources or when using blends of erythritol and one or more high intensity sweeteners as a single sweetener source.

Other typical micro-ingredients for supplementing a finished beverage product may include micro-ingredient flavor additives. Micro-ingredient flavor additives may include additional flavor options that can be added to a base beverage flavor. The micro-ingredient flavor additives may be non-sweetener beverage component concentrates. For example, a base beverage may be a cola flavored beverage, whereas cherry, lime, lemon, orange, and the like may be added to the cola beverage as flavor additives, sometimes referred to as flavor shots. In contrast to recipe-based flavor versions of finished beverages, the amount of micro-ingredient flavor additive added to supplement a finished beverage may be consistent among different finished beverages. For example, the amount of cherry non-sweetener component concentrate included as a flavor additive or flavor shot in a cola finished beverage may be the same as the amount of cherry non-sweetener component concentrate included as a flavor additive or flavor shot in a lemon-lime finished beverage. Additionally, whereas a recipe-based flavor version of a finished beverage is selectable via a single finished beverage selection icon or button (e.g., cherry cola icon/button), a flavor additive or flavor shot is a supplemental selection in addition to the finished beverage selection icon or button (e.g., cola icon/button selection followed by a cherry icon/button selection).

As is generally understood, such beverage selections may be made through a touchscreen user interface or other typical beverage user interface selection mechanism (e.g., buttons) on a beverage dispenser. The selected beverage, including any selected flavor additives, may then be dispensed upon the beverage dispenser receiving a further dispense command through a separate dispense button on the touchscreen user interface or through interaction with a separate pour mechanism such as a pour button (electromechanical, capacitive touch, or otherwise) or pour lever.

In the traditional BIB flavored syrup delivery of a finished beverage, a macro-ingredient flavored syrup that contains all of a finished beverage's sweetener, flavors, and acids is mixed with a diluent source such as plain or carbonated water in ratios of around 3:1 to 6:1 of diluent to the syrup. In contrast, for a micro-ingredient delivery of a finished beverage, the sweetener(s) and the non-sweetener beverage component concentrates of the finished beverage are all separately stored and mixed together about a nozzle when the finished beverage is dispensed. Example nozzles suitable for dispensing of such micro-ingredients include those described in commonly owned U.S. provisional patent application Ser. No. 62/433,886, entitled “Dispensing Nozzle Assembly,” PCT patent application Ser. No. PCT/US15/026657, entitled “Common Dispensing Nozzle Assembly,” U.S. Pat. No. 7,866,509, entitled “Dispensing Nozzle Assembly,” or U.S. Pat. No. 7,578,415, entitled “Dispensing Nozzle Assembly,” which are all herein incorporated by reference in their entirety.

In operation, the beverage dispenser may dispense finished beverages from any one or more of the macro-ingredient or micro-ingredient sources described above. For example, similar to the traditional BIB flavored syrup delivery of a finished beverage, a macro-ingredient flavored syrup may be dispensed with a diluent source such as plain or carbonated water to produce a finished beverage. Additionally, the traditional BIB flavored syrup may be dispensed with the diluent and one or more micro-ingredient flavor additives to increase the variety of beverages offered by the beverage dispenser.

Micro-ingredient-based finished beverages may be dispensed by separately dispensing each of the two or more non-sweetener beverage component concentrates of the finished beverage along with a sweetener and diluent. The sweetener may be a macro-ingredient sweetener or a micro-ingredient sweetener and the diluent may be water or carbonated water. For example, a micro-ingredient-based cola finished beverage may be dispensed by separately dispensing a food acid concentrate components of the cola finished beverage, such as phosphoric acid, food acid-degradable concentrate components of the cola finished beverage, such as flavor oils, macro-ingredient sweetener, such as HFCS, and carbonated water. In another example, a micro-ingredient-based diet-cola finished beverage may be dispensed by separately dispensing a food acid concentrate components of the diet-cola finished beverage, food acid-degradable concentrate components of the diet-cola finished beverage, micro-ingredient sweetener, such as aspartame or an aspartame blend, and carbonated water. As a further example, a mid-calorie micro-ingredient-based cola finished beverage may be dispensed by separately dispensing a food acid concentrate components of the mid-calorie cola finished beverage, food acid-degradable concentrate components of the mid-calorie cola finished beverage, a reduced amount of a macro-ingredient sweetener, a reduced amount of a micro-ingredient sweetener, and carbonated water. By reduced amount of macro-ingredient and micro-ingredient sweeteners, it is meant to be in comparison with the amount of macro-ingredient or micro-ingredient sweetener used in the cola finished beverage and diet-cola finished beverage. As a final example, a supplementally flavored micro-ingredient-based beverage, such as a cherry cola beverage or a cola beverage with an orange flavor shot, may be dispensed by separately dispensing a food acid concentrate components of the flavored cola finished beverage, food acid-degradable concentrate components of the flavored cola finished beverage, one or more non-sweetener micro-ingredient flavor additives (dispensed as either as a recipe-based flavor version of a finished beverage or a flavor shot), a sweetener (macro-ingredient sweetener, micro-ingredient sweetener, or combinations thereof), and carbonated water. While the above examples are provided for carbonated beverages, they apply to still beverages as well by substituting carbonated water with plain water.

The various ingredients may be dispensed by the beverage dispenser in a continuous pour mode where the appropriate ingredients in the appropriate proportions (e.g., in a predetermined ratio) for a given flow rate of the beverage being dispensed. In other words, as opposed to a conventional batch operation where a predetermined amount of ingredients are combined, the beverage dispenser provides for continuous mixing and flows in the correct ratio of ingredients for a pour of any volume. This continuous mix and flow method can also be applied to the dispensing of a particular size beverage selected by the selection of a beverage size button by setting a predetermined dispensing time for each size of beverage.

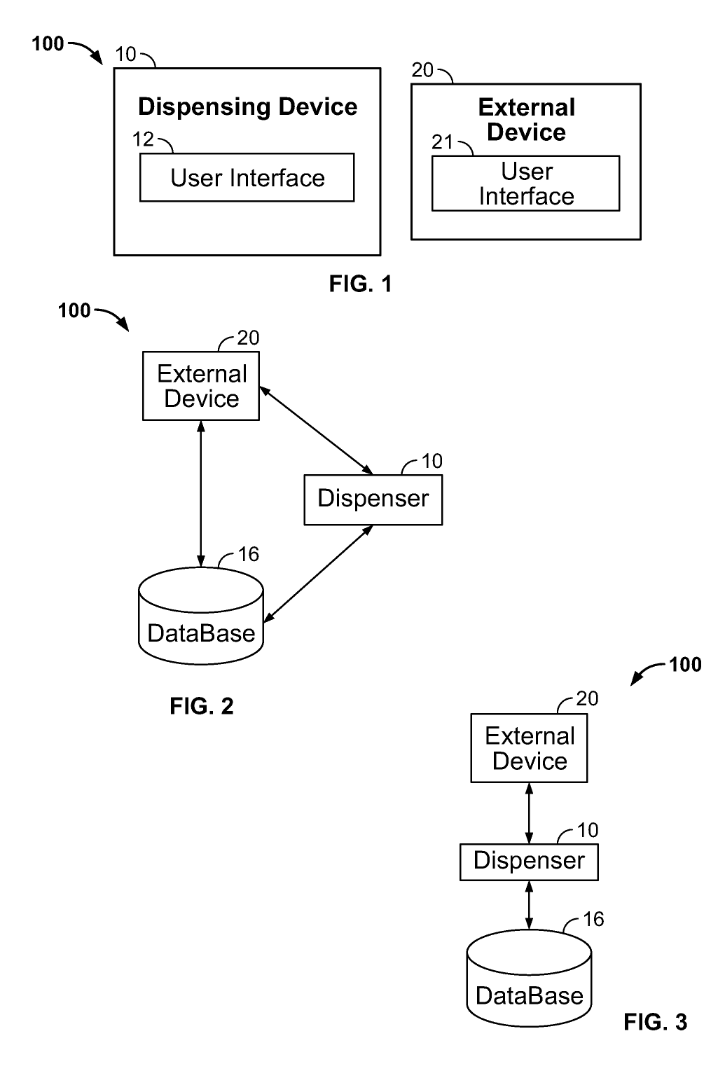

FIG. 1 is a block diagram illustrating an example of a beverage dispensing system 100 in accordance with the present disclosure. The system 100 includes a beverage dispensing device 10, which could be any of a number of types of beverage dispensers. For example, in various embodiments the dispensing device 10 is a vending machine that dispenses bottled or canned beverages, a soft drink dispenser that includes one or more dispensing valves for selectively dispensing respective beverages, or a commercial dispensing device that mixes selected beverage ingredients to dispense desired beverages individually.

The system 100 further provides beverage dispensing controls, implemented either on the dispenser 10 itself, or provided remotely on the external device 20 or other device, such that a user can set controls such as preferences or limitations that instruct the dispenser. In various embodiments, such controls may include restrictions limiting types of beverages, times beverages may be dispensed, number of beverages or amount dispensed, number of calories that can be dispensed in a given time period, etc. For example, the system 100 allows an authorized party (retail managers, service providers, administrators, caretakers, teachers, proprietors, bottlers, machine owners, etc.) to set up user IDs and profiles for one or more users. Each user selects a beverage and then is identified and/or authenticated, for example, by entering a personal PIN or passcode to dispense a beverage. Other examples of authentication processes include providing a phone number, email address, swipe pattern, bio-identification such as fingerprints, etc.

The user and the associated profile are identified, and beverages are dispensed accordingly. The user receives a message if the selection is outside the approved settings.

Some embodiments disclosed herein may include the beverage dispensing capabilities and the beverage pour controls on the dispenser 10 itself. In other implementations, portions of the system 100 are provided remotely from the dispensing device 10, such as on the external device 20, which could be any computing device that is external to the dispensing device 10. Examples of external devices include desktop or laptop computers, tablet computers, mobile phones, smart phones, wearable technology, etc.

FIGS. 2 and 3 illustrate example arrangements that support connectivity and control between the dispensing device 10 and a user. In FIG. 2, a dispenser control application, user profile settings, etc. are stored on in a database 16 that may be implemented by a memory of the dispensing device 10. The external device 20, the dispenser 10 and database 16 are all interconnected by any appropriate communications connection, such one or more as wired or wireless connections. FIG. 3 illustrates another example, in which the external device 20 does not directly communicate with the database 16, but rather communicates with the database 16 via the dispenser 10. In some embodiments, the external device 20 connects to the dispenser 10 via a wireless connection (discussed further below) and authenticates using a secure application operating on one or both of the external device 20 and/or dispenser 10. The dispenser 10 accesses the database 16 via any suitable wired or wireless connection.

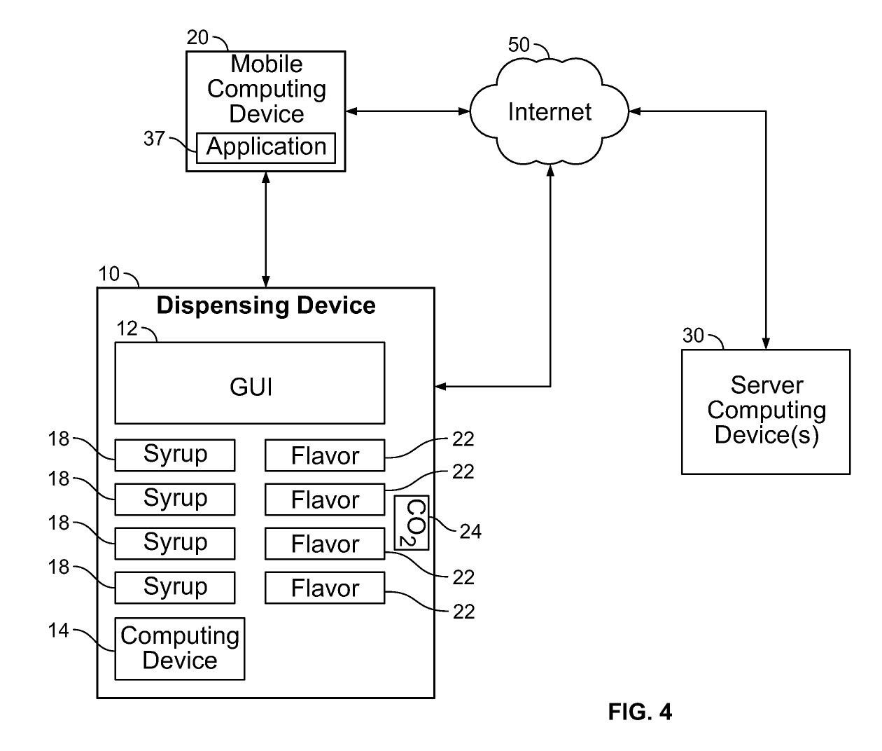

FIG. 4 is a block diagram illustrating further aspects of the beverage dispensing system 100 shown in FIG. 1. In the embodiment illustrated in FIG. 4, the dispensing device 10 is in communication with an external computing device 20, such as a mobile computing device (e.g., a smartphone, wearable like a smartwatch, tablet or laptop computer) and one or more server computing devices 30 (over the Internet 50).

The mobile computing device 20 may further comprise an application 37 for communicating with the dispensing device 10 and Internet 50. In accordance with some embodiments, the communication between the mobile computing device 20 and the dispensing device 10 may be accomplished utilizing any number of communication techniques known to those skilled in the art including, but not limited to, BLUETOOTH wireless technology, Near Field Communication (“NFC”), Wi-Fi and other wireless communication standards or technologies. The mobile computing device 20 may also communicate with the dispensing device 10 by scanning a one or two-dimensional barcode (e.g., a QR code) or other symbol shown on a tag or sticker affixed to, printed on the dispensing device 10 or displayed on a display of the dispensing device 10. Such an embodiment is further disclosed, for example, in copending U.S. Patent Application Publication No. US 2015/0039776A1, which is incorporated by reference in its entirety.

In the example shown in FIG. 4, the dispensing device 10 comprises one or more beverage bases or beverage base components such as beverage bases 18 as well as flavors (i.e., flavoring agents, flavor concentrates, or flavor syrups) 22. In some embodiments, the beverage bases 16 may be concentrated syrups or other types of beverage bases. In some embodiments, the beverage bases 16 may be replaced with or additionally provided with beverage base components. In some embodiments, each of the beverage bases 16 or beverage base components and each of the flavors 22 may be separately stored or otherwise contained in individual removable cartridges which are stored in the dispensing device 10. The dispensing device 10 may automatically identify the cartridges upon installation by a user or the user may be prompted to identify the cartridges when they are installed. It should be appreciated that the aforementioned beverage components (i.e., beverage bases or beverage base components and flavors) may be combined, along with other beverage ingredients, to dispense various beverages or blended beverages (i.e., finished beverage products) from the dispensing device 10. It should be understood however, that the dispensing device 10 may also be configured to dispense beverage components individually. In some embodiments, the dispensing device 10 may be configured to dispense beverage base components so as to form a beverage base. The other beverage ingredients 30 may include diluents such as still or carbonated water, functional additives, or medicaments, for example. The other beverage ingredients 30 may be installed in the dispensing device 10, pumped to the dispensing device 10, or both. The carbonated water may be produced in the dispensing device 10 through mixing of CO₂ 24 and still water such as in a carbonator or other device that produces carbonated water.

The dispensing device 10 includes a computing device 14 that, among other things, is configured to generate a graphical user interface (“GUI”) 12 on a display screen (not shown) of the dispensing device 10. The GUI 12 may be utilized to select and individually dispense one or more beverages from the dispensing device 10. The beverages may be dispensed as beverage components in a continuous pour operation whereby one or more selected beverage components continue to be dispensed while a pour input is actuated by a user or in a batch pour operation whereby a predetermined volume of one or more selected beverage components are dispensed (e.g., one ounce at a time).

The GUI 12 on the dispensing device 10 may be addressed via a number of methods to select and dispense beverages. For example, a user may interact with the GUI 12 via touch input to navigate one or more menus from which to select and dispense a beverage. As another example, a user may type in a code using an onscreen or physical keyboard (not shown) on the dispensing device 10 to navigate one or more menus from which to select and dispense a beverage. As yet another example, a user may use the mobile computing device 20 to scan a one or two-dimensional barcode (e.g., a QR code) or other symbol shown on a tag or sticker affixed to, printed on the dispensing device 10 or displayed on a display of the dispensing device 10 to select a beverage for dispensing.

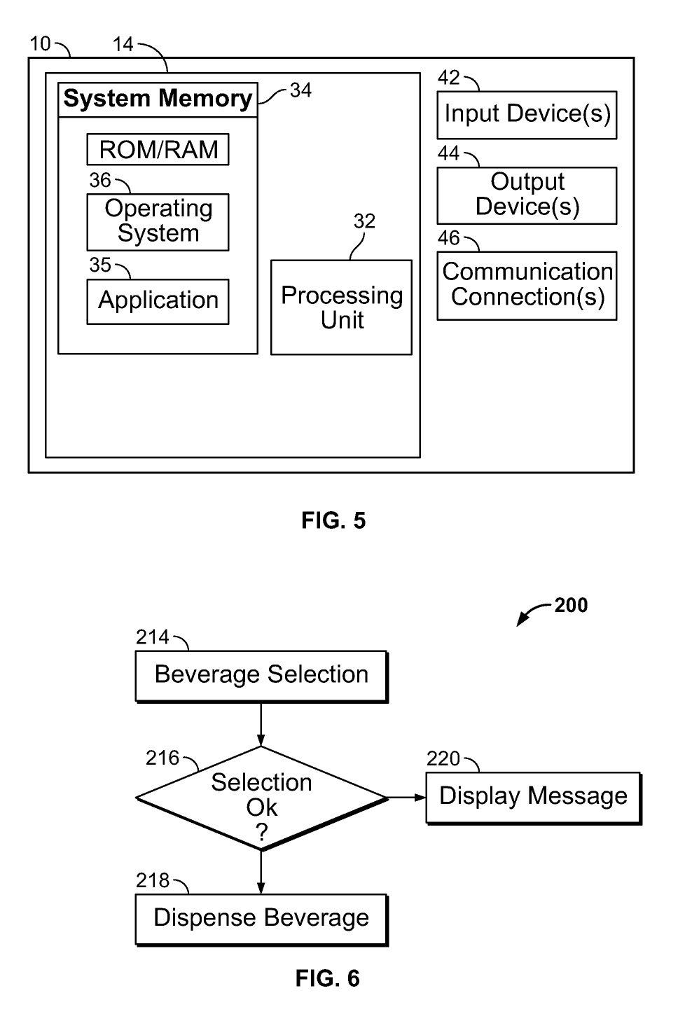

FIG. 5 is a simplified block diagram illustrating further aspects of the dispensing device 10, including an example of the computing device 14 of the dispensing device 10. In a basic configuration, the computing device 14 includes at least one processing unit 32 and a system memory 34. Depending on the configuration and type of computing device, system memory 34 may comprise, but is not limited to, volatile (e.g. random access memory (RAM)), non-volatile (e.g. read-only memory (ROM)), flash memory, or any combination. The system memory 34 may include an operating system 36 and software code for implementing various applications 35. The operating system 36 may be suitable for controlling operation of the dispensing device 10.

The external device 20 may also include additional data storage devices (not shown) which may be removable and/or non-removable such as, for example, magnetic disks, optical disks, solid state storage devices (“SSD”), flash memory or tape. The dispensing device 10 may also have input device(s) 42 such as a keyboard, a mouse, a pen, a sound input device (e.g., a microphone), a touch input device, etc. Output device(s) 44 such as a touchscreen display, speakers, a printer, etc. may also be included. The aforementioned devices are examples and others may be used. Communication connection(s) 46 may also be included and utilized to connect to the Internet 50 (or other types of networks) as well as to remote computing systems such as the external device 20 and server computer 30.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The system memory 2104 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the dispensing device 10. Any such computer storage media may also be part of the dispensing device 10. Computer storage media does not include a carrier wave or other propagated or modulated data signal.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As noted above, various disclosed examples include beverage dispensing controls, where a user can set preferences/limitations that instruct the dispenser. Such controls may include restrictions limiting types of beverages, times beverages may be dispensed, the number of calories that can be dispensed in a given time period, number of beverages or amount poured. For example, the system 100 allows an authorized administrator (retail managers, service providers, caretakers, teachers, proprietors, bottlers, machine owners, etc.) to establish beverage dispensing controls. FIG. 6 is a flow diagram generally illustrating a beverage dispensing method 200 in accordance with aspects of the disclosure. As shown in FIG. 4, a beverage selection is received in operation 214, and if the selection is in accordance with previously defined controls as determined in operation 216, the beverage is dispensed in operation 218. If the selection is not in accordance with the controls defined in the user profile, an error message may be displayed in operation 220. Various types of controls are employed in implementations disclosed herein. For example, defined dispensing controls may be as simple as identifying the user attempting to dispense the beverage as an authorized user. Further examples of dispensing controls are described below.

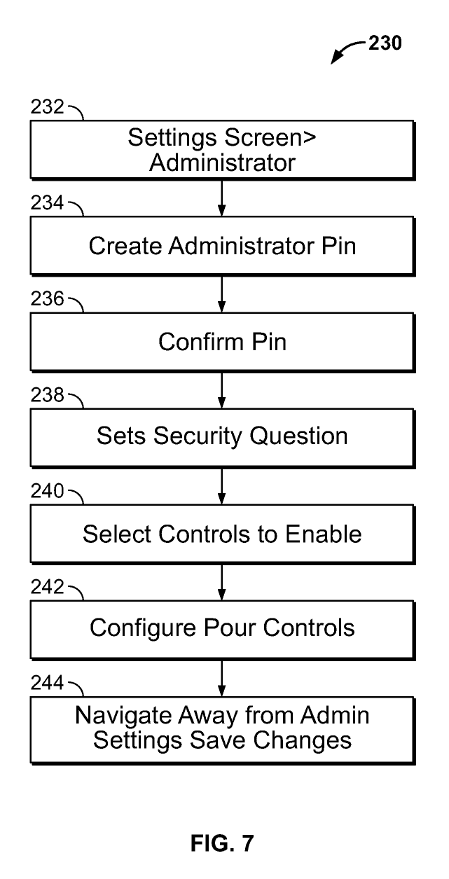

FIG. 7 illustrates aspects of a process for defining pour controls as referred to in the discussion of FIG. 6. Dispensing controls included therein are stored in a database 16 implemented in the memory 34 of the computing device 14. Initially, an administrator such as a retail manager or other service providers accesses an administrator settings screen displayed on by the user interface 12 in an operation 232. The administrator creates an administrator PIN in operation 234 and confirms the PIN in operation 236 (or, in other embodiments, other authentication methods, such as biometrics, can be used). Additional security measures are included in the illustrated example, including setting one or more security questions in operation 238. Once the administrator account has been created, the administrator may enable desired dispensing controls in operation 240, and configure the dispensing controls in operation 242. The administrator may then navigate way from the settings screen and save the controls to the system memory in operation 244.

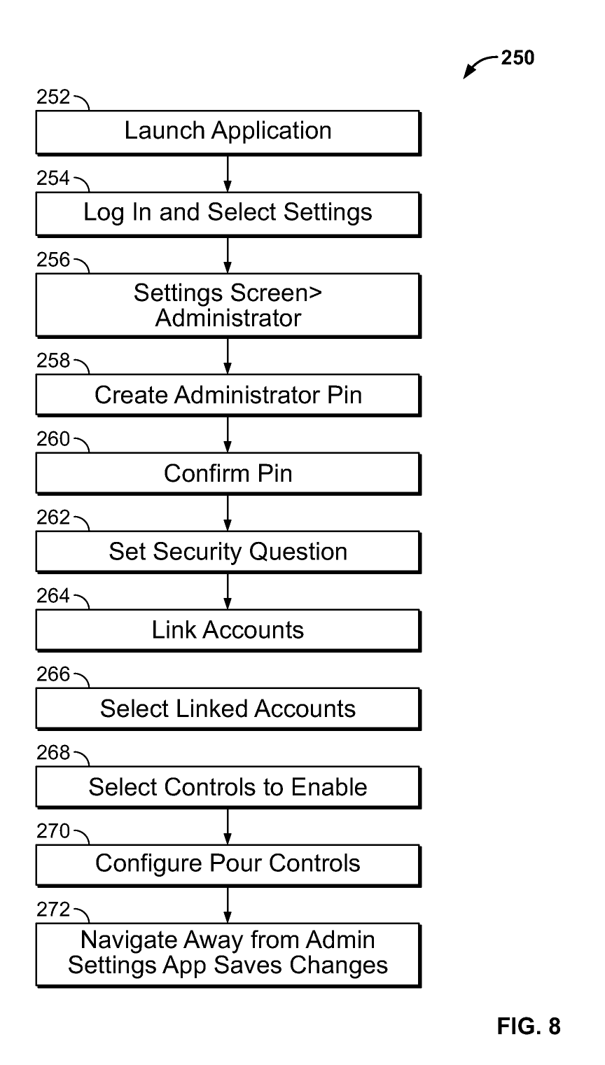

FIG. 8 illustrates another process 250 for creating and saving pour controls, in which the controls are created remotely from the dispensing device 10 using an application 37 on the remote device 20 or other remote device. Accordingly, the process begins with launching the remote application 37 in operation 252, and the administrator logs in and selects the desired settings in operation 254. The administrator accesses an administrator settings screen displayed on the remote device 20 in operation 256. The administrator creates an administrator PIN in operation 258 and confirms the PIN in operation 260 (or, in other embodiments, other authentication methods, such as biometrics, can be used). Additional authentication measures, such as one or more security questions, email address, etc. may optionally be set in operation 262.

If dispensing controls are being established for multiple accounts, the accounts may be linked in operation 264. The accounts may be linked by entering other user IDs and passwords, or if the administrator has consent from other users through their app settings as granting administrator access. One or more of the linked accounts are selected in operation 266, and the desired dispensing controls are enabled in operation 268. Dispensing controls are configured in operation 270. The administrator may then navigate way from the settings screen and the app 37 saves the controls to the appropriate memory in operation 272.

In some examples, dispensing controls may be established for multiple individual users, rather than generally for a particular dispensing device 10. The dispensing controls may be associated with user profiles, which could correspond to individual beverage consumers or a class of consumers. For example, convenience store proprietors could create user profiles for each of their employees, providing one set of controls for a clerk and different controls for a shift manager. Or, an amusement park manager could create user profiles corresponding to classes of consumers, whereby a first set of controls could be applied to a first user profile for same-day consumers (e.g. free refills) and another set of controls could be applied to a second user profile for prior purchase consumers (e.g. 99 cent refills).

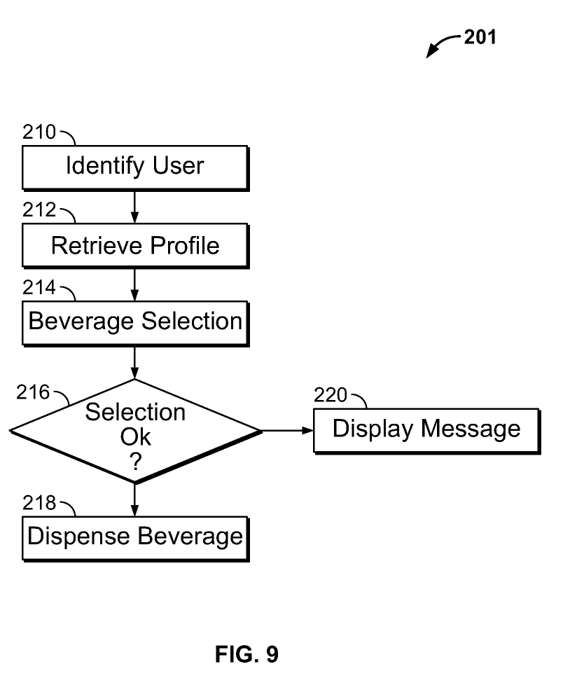

FIG. 9 generally illustrates a beverage dispensing method 201 in which dispensing controls are associated with one or more user profiles. In operation 210, the user of the dispensing device 10 is identified. In some examples, the user is identified by entering a PIN, though other forms of identification are employed in other implementations. For instance, a user may be identified by logging into a secure application, by providing a bar code, by biometric identifiers, etc. The appropriate user profile is retrieved in operation 212, and a beverage selection 214 is compared to the controls contained in the user profile in operation 216. If the selection is in accordance with previously defined controls associated with the user profile, the beverage is dispensed in operation 218. If the selection is not in accordance with the controls defined in the user profile, an error message may be displayed in operation 220.

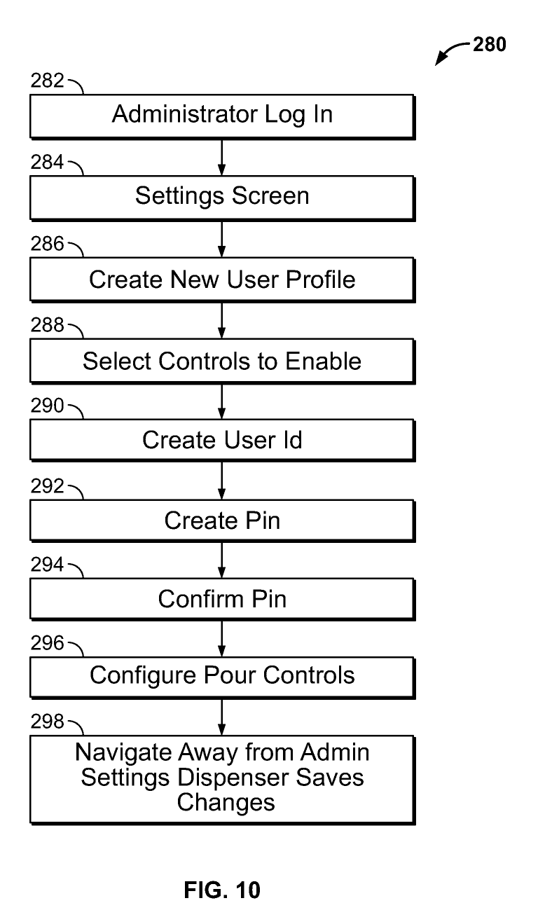

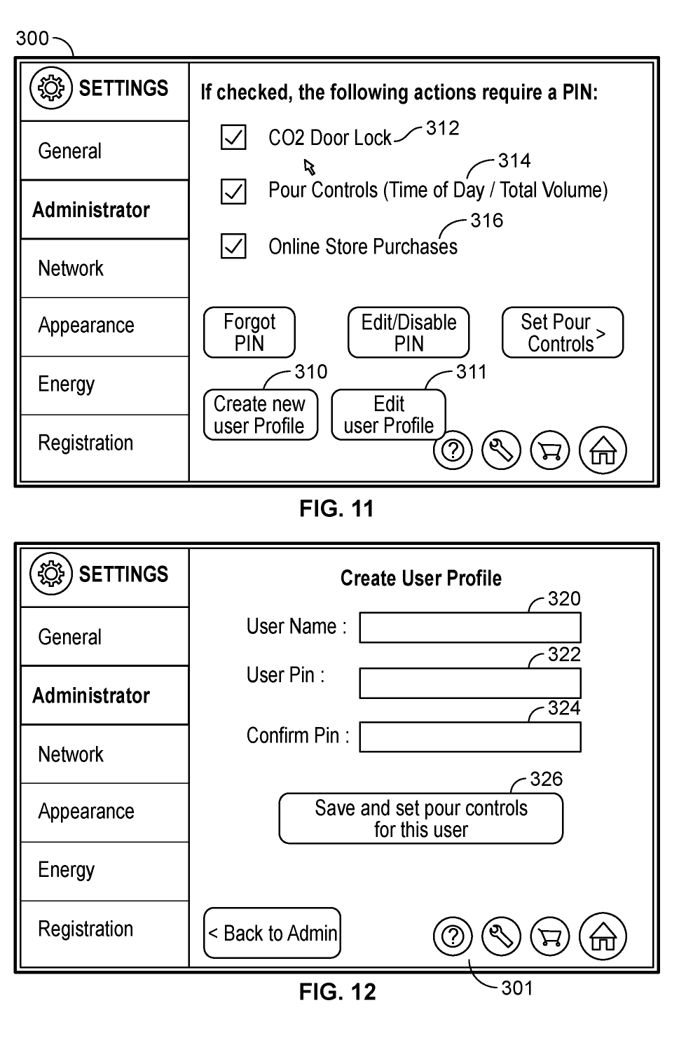

FIG. 10 illustrates a process 280 for creating individual or class user profiles, and FIGS. 11-14 illustrate example user interface screens implementing the process 280. In the process shown in FIG. 10, the profiles and associated controls would typically be stored in the system memory 34, and the user interface screens shown in FIGS. 11-14 may be displayed on the user interface 12 of the dispensing device 10 itself. In other embodiments, the process illustrated in FIG. 10 could be implemented on a remote device, such as the external device 20, and the user interface screens may be displayed on the user interface 21 of the corresponding device 20.

In operation 282 an administrator such as a retail manager, service provider, machine owner, proprietor, etc. logs into the application and navigates to a settings screen in operation 284, an example of which is shown in FIG. 11. Referring to FIGS. 10 and 11, on the settings screen 300, the administrator may click on the create new user profile control 310 as indicated in operation 286. The settings screen 300 allows the administrator to select desired controls to enable, such as door lock, dispensing controls and online purchase restrictions 312, 314, 316 in operation 288. The present disclosure is concerned primarily with controls on beverage dispensing, and thus the dispensing controls 314 are selected. Some embodiments allow additional controls to be established, such as restrictions relating to the dispensing machine hardware (CO2 door lock 312, for example) and other actions related to the machine such as enabling or defining automatic online purchases 316 of beverage supplies.

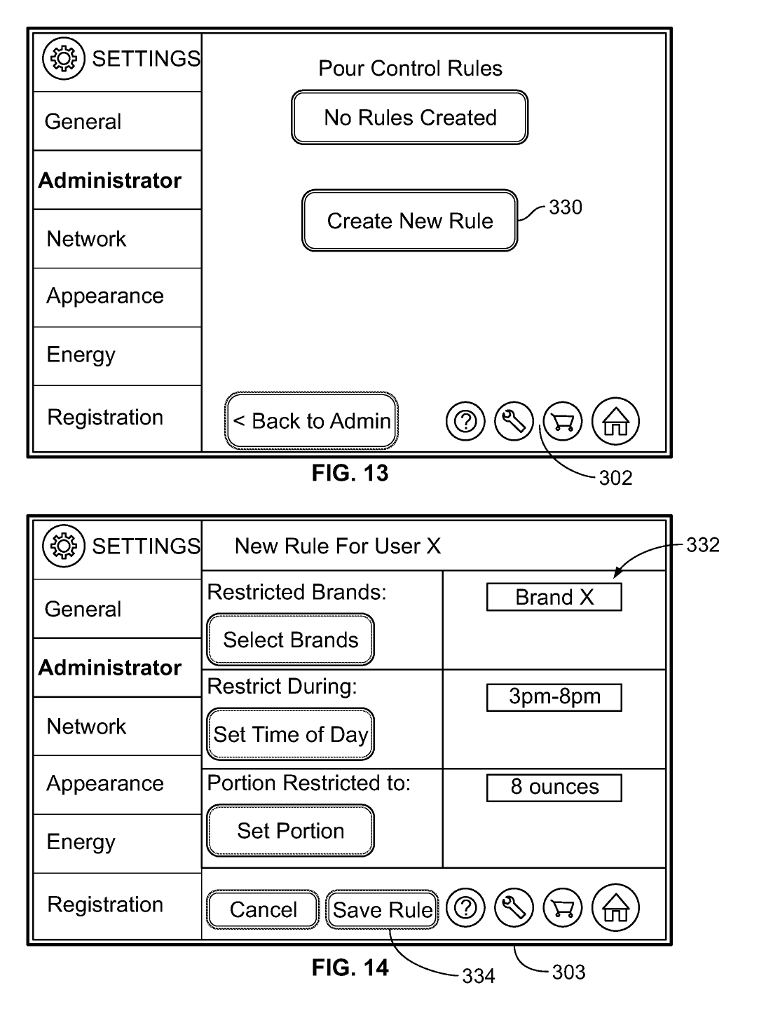

FIG. 12 illustrates an example user interface screen 301 for creating a user profile. In operation 290 of FIG. 10, the administrator creates a user name or ID, and in operations 292 and 294 a PIN is created and confirmed for the user ID (or, in other embodiments, other authentication methods, such as biometrics, can be used). Input blocks 320, 322 and 324 are provided on the user interface screen 301 for entering the user ID, PIN and PIN confirmation, respectively. The administrator may then click on the save and set pour controls button 326, which causes the user interface screen 302 shown in FIG. 13 to be displayed. The administrator selects the create new rule button 330, and then may configure the desired dispensing controls using the user interface screen 303 shown in FIG. 14, which is reflected in operation 296 of FIG. 10.

FIG. 14 illustrates examples of pour restrictions 332 that may be set by the administrator. In the example shown in FIG. 14, the administrator may select restricted beverage brands, time of day restrictions, and portion restrictions. Thus, the administrator may select restrict dispensing of Brand X to 3 pm to 8 pm, and only allow up to 8 ounces of Brand X to be dispensed during this time. Of course, FIG. 14 illustrates a few of many possible pour controls that may be configured in various embodiments. For example, beverages could be restricted based on nutritional content (sugar free, caffeine free, calories per serving, etc.), beverage type (carbonated or uncarbonated beverages, fruit juices, etc.), day of the week, daily calorie value dispensed, number of servings dispensed, product cost, etc. Once the desired controls 332 have been established, the controls are saved by clicking the save rule button 334 as reflected in operation 298 of FIG. 10. For certain established controls, such as those relating to portion restrictions (total volume, total calories, amount of sugar, etc.), characteristics of the beverages dispensed (e.g., volume of beverage dispensed, caloric value of the beverage dispensed, amount of sugar in the beverage dispensed, etc.) for a given user or class of users may be saved to a memory of the dispensing device or external device each time a beverage is dispensed for the user or class of users. For example, if dispensing controls include a restriction to a predetermined maximum number of calories during a specified time period, each time a beverage is dispensed during the specified time, the number of calories dispensed is saved and tallied against the number of calories of any prior beverage dispenses during the specified time period. If the maximum number of calories is reached during the specified time period, no further beverages would be dispensed.

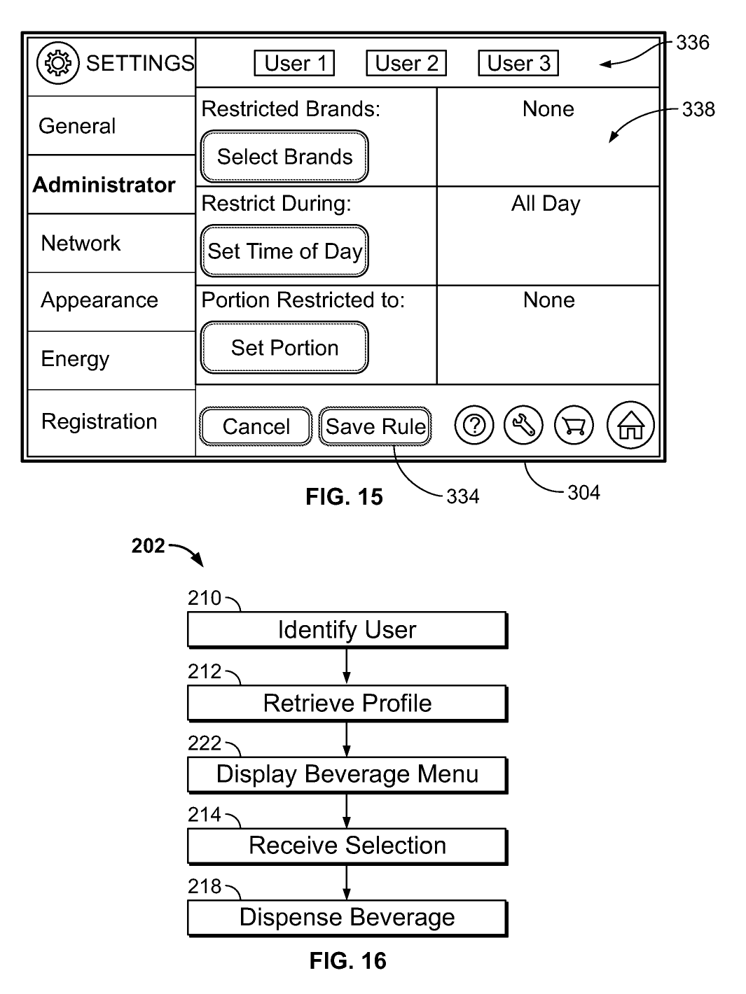

Referring back to FIG. 11, an administrator may edit user profiles by clicking the edit user profile button 311. FIG. 15 illustrates an example of an edit screen 304 displayed in response to clicking the edit button 311. The edit screen 304 displays a list of user profiles 336, allowing the administrator to select the desired profile for editing. The existing controls 338 are displayed for the selected user profile 336, which may be edited by the administrator. When the edits are complete, the profile may be saved by clicking the save rule button 334.

FIG. 16 illustrates another example of a beverage dispensing method 202 in accordance with a disclosed embodiment where processes in addition to those shown in FIGS. 6 and 9 are included. In operation 210, the user is identified and the appropriate user profile is retrieved in operation 212 as discussed above in conjunction with FIGS. 6 and 9. Based on the retrieved profile and the controls defined therein, a menu of available beverages is displayed on the appropriate user interface in operation 222. Thus, if the predefined controls included in the profile associated with the identified user only allow non-carbonated beverages, only such non-carbonated beverages are included in the displayed menu. Further, if there are time of day restrictions, those also would be considered when displaying the menu in operation 222. For example, if a time of day restriction has been established in which only non-caffeinated beverages are allowed after 7 pm, only such beverages would be displayed in operation 222 if it is later than 7 pm.

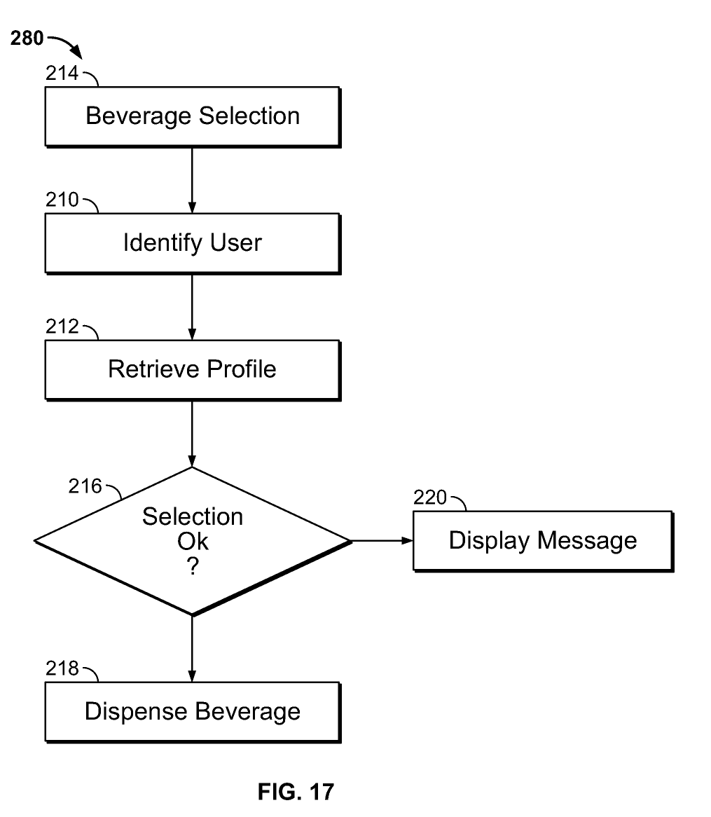

FIG. 17 illustrates another beverage dispensing method 203, in which the beverage selection is received prior to identifying the user. Beginning with operation 214, a beverage selection is received. Following the beverage selection, the user is identified in operation 210 by entering a PIN, logging into a secure application, etc. The user profile corresponding to the identified user is retrieved in operation 212, and based on the controls contained therein as compared to the selected beverage in operation 212, the beverage is dispensed in operation 218 or an error message is displayed in operation 220.

In some examples, especially those implemented in conjunction with commercial beverage dispensing systems, beverage dispensing controls may be implemented through a point of sale (POS) system. For instance, some consumer rewards applications allow a consumer to log in via a remote device such as a smart phone or other mobile computing system, and make purchases such as a beverage purchase. With this type of system, the user is authenticated through the application.

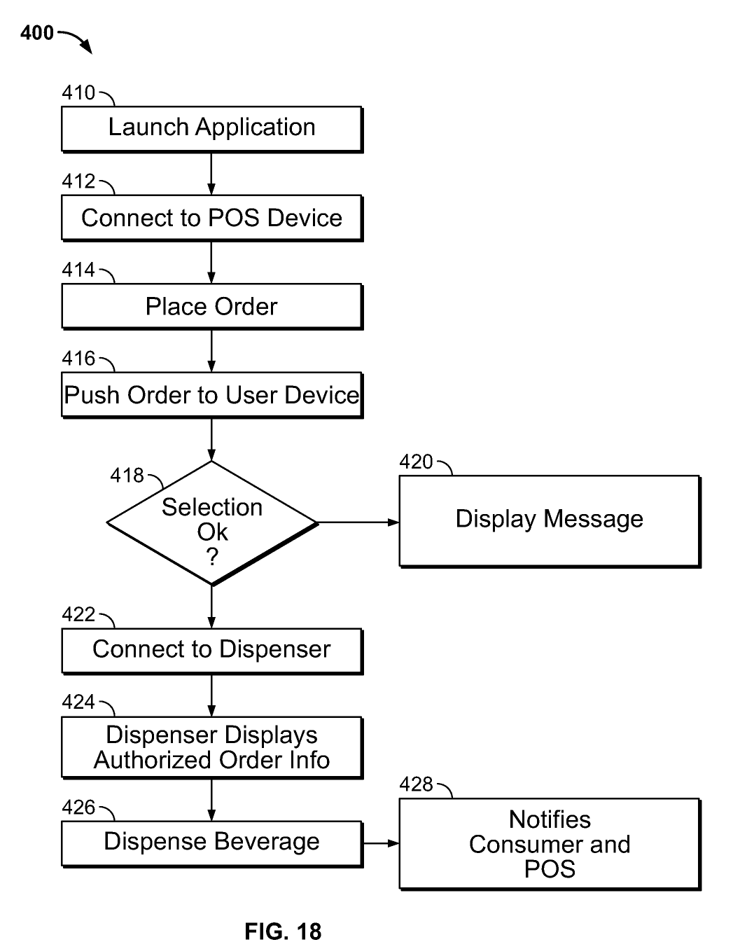

FIG. 18 illustrates a process 400 in which a consumer operates a customer application associated with a commercial establishment such as a retail store, fast food restaurant, supermarket, etc. The user logs into the customer application using a remote device such as a mobile phone in operation 410, which is linked to a beverage dispensing system such as the dispenser system 100 disclosed herein, as well as a POS system for the establishment associated with the customer application. The application connects to the POS system by any suitable method in operation 412. Once the consumer makes a beverage purchase through the POS system in operation 414, the beverage order is stored in a memory accessible by the beverage dispenser and passed to the user's mobile device through the application in operation 416.

Logging into the application in operation 410 also functions to identify the user, and based on this identification the dispenser retrieves the associated user profile and determines whether the ordered beverage meets the controls contained in the profile at operation 418. If the ordered beverage is not in accordance with the user profile, an error message is displayed in operation 420. If the ordered beverage is in accordance with the user profile, the user's mobile device then connects to the dispenser in operation 422, which displays the beverage order in operation 424. The ordered beverage is dispensed in operation 426, and once the order has been fulfilled, the dispenser notifies both the consumer (through the application) and the POS that the order has been fulfilled and is no longer valid in operation 428.

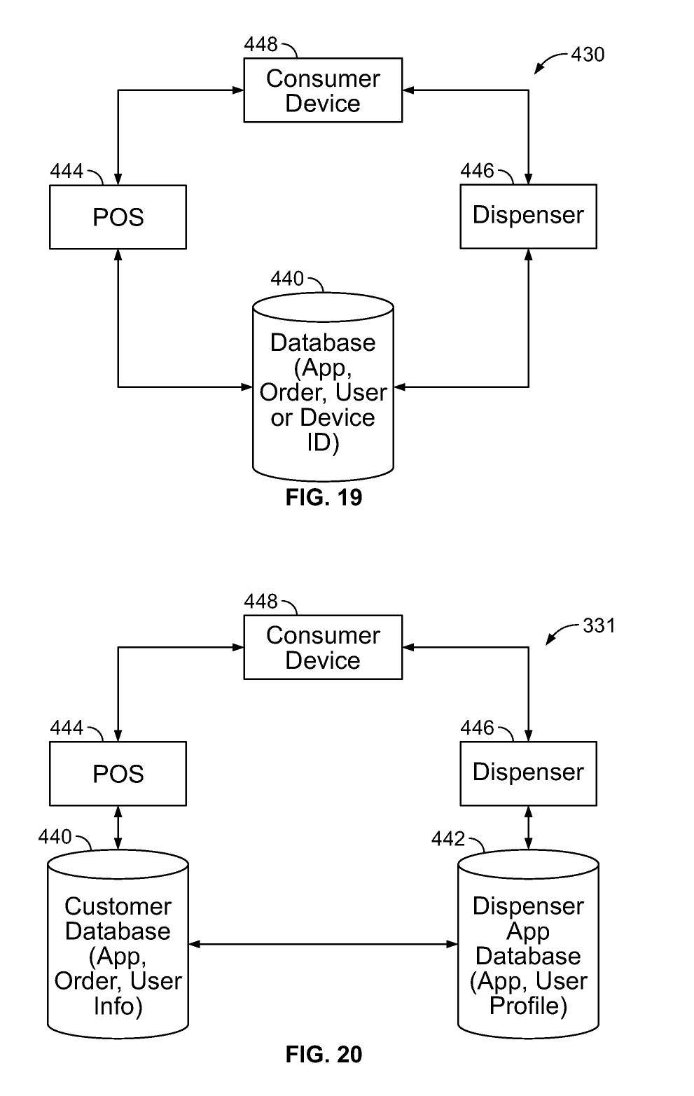

FIGS. 19 and 20 illustrate examples of connectivity between components of a beverage dispensing system suitable for implementing the method shown in FIG. 17.

FIG. 19 illustrates an example system 430 in which the customer application, the beverage order, the user or device ID, and the user profile are all stored in a common database 440. The POS system 444 and beverage dispenser 446 both communicate with the database 440 and the consumer device 448 that runs the customer application.

In the example, system 331 shown in FIG. 20, the POS 444 and dispenser 446 access respective databases 440, 442. For example, the customer application, beverage order and user information may be stored in the POS database 440, while the dispenser application and user profile may be stored in the dispenser database 442.

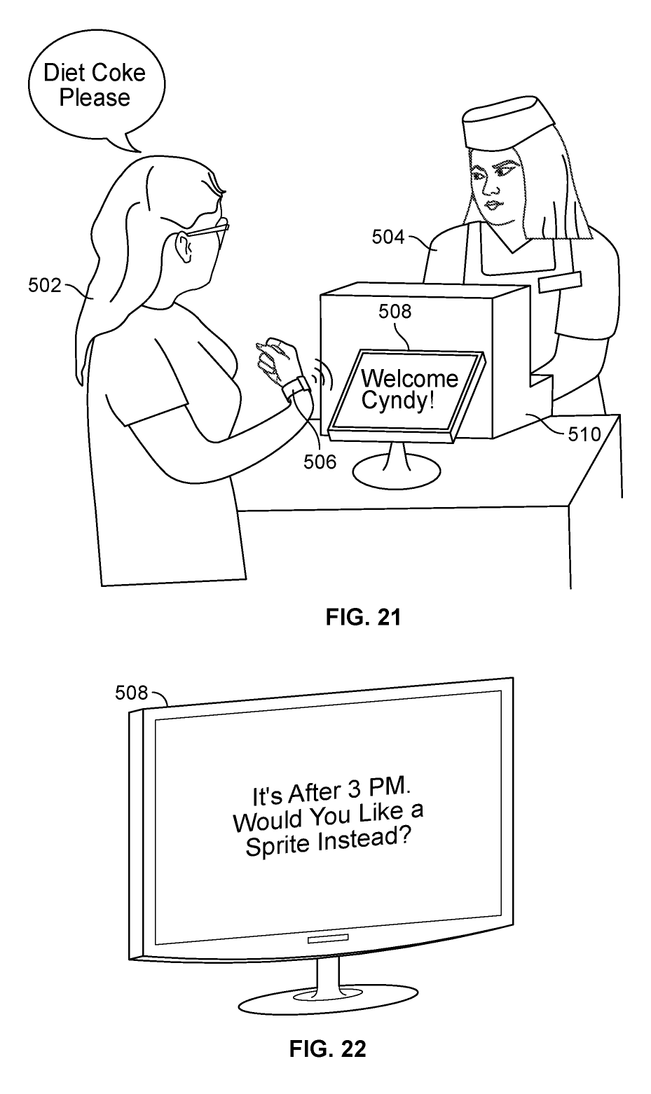

Referring now to FIGS. 21-22, a customer 502 is illustrated interacting with a service provider 504 and a POS 510 and dispensing device 520. In this example, the POS 510 includes an interactive display 508 that communicates with the customer 502.

Prior to or as part of this interaction with the service provider 504, the customer 502 creates a profile that defines the customer's preferences, as described above (see, e.g., FIG. 12). When the customer 502 arrives at the POS 510, the customer 502 is identified (e.g., using automated or manual processes), and the customer's profile is loaded. As the customer 502 orders a beverage, the POS 510 consults the customer's profile to assess the customer's preferences.

In this example, the customer 502 requests a Diet Coke®. The POS 510 logs that request and compares the request to the customer's profile. As shown in FIG. 22, the interactive display 508 can provide recommendations based upon the selection and the customer's profile. In this example, the interactive display 508 recommends a different beverage (e.g., a Sprite® that does not contain caffeine) based upon the preferences in the customer's profile, such as limiting total caffeine intake and/or limiting caffeine intake after a certain time of day.

As illustrated, once the beverage selection is confirmed, the beverage selection can be wirelessly communicated to a device held by the customer 502, such as a wearable device like a smartwatch 506. In other example, other ways to capture the order, such as using a smartphone or other electronic device provided by the service provider 504 to the customer 502, can be used.

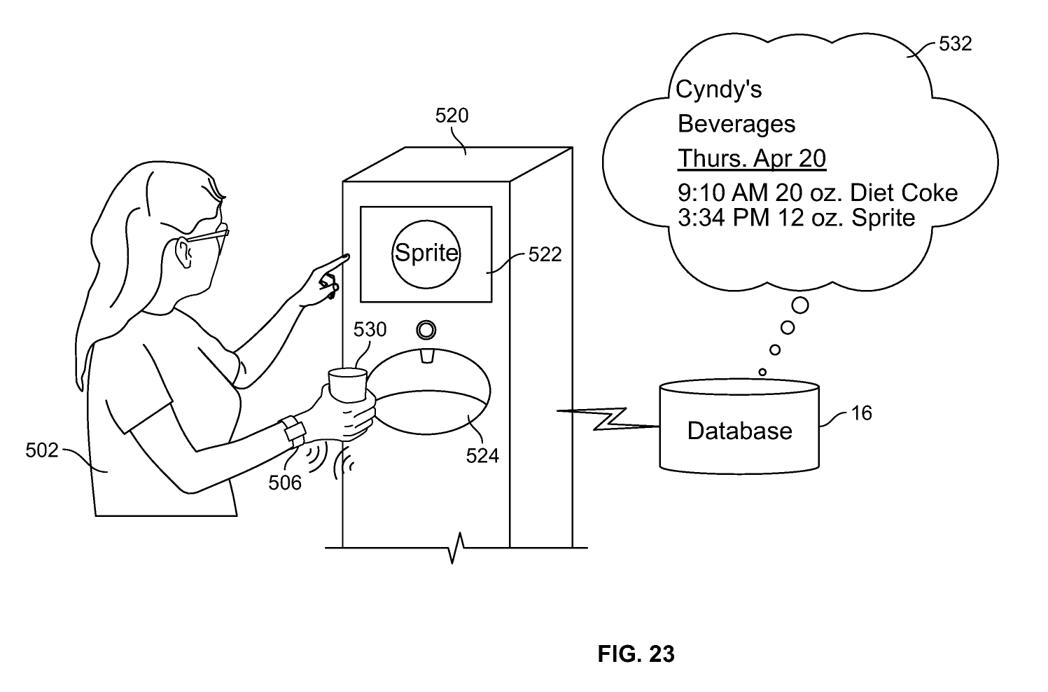

As shown in FIG. 23, another customer approaches the dispensing device 520 to obtain the selected beverage. The smartwatch 506 communicates wirelessly (e.g., using NFC or other communication schemes) with the dispensing device 520 to authorize the dispense of the beverage, and the selection is shown on the display 522. The customer 502 can thereupon place a cup 530 within the dispensing cavity 524 of the dispensing device 520 to obtain the beverage.

Upon dispensing, the dispensing device 520 communicates with the database 16 to log the beverage that was provided to the customer 502. In this example, a portion of the customer's profile 532 logs the various beverages that are dispensed to the customer 502 throughout the day. Other configurations are possible.

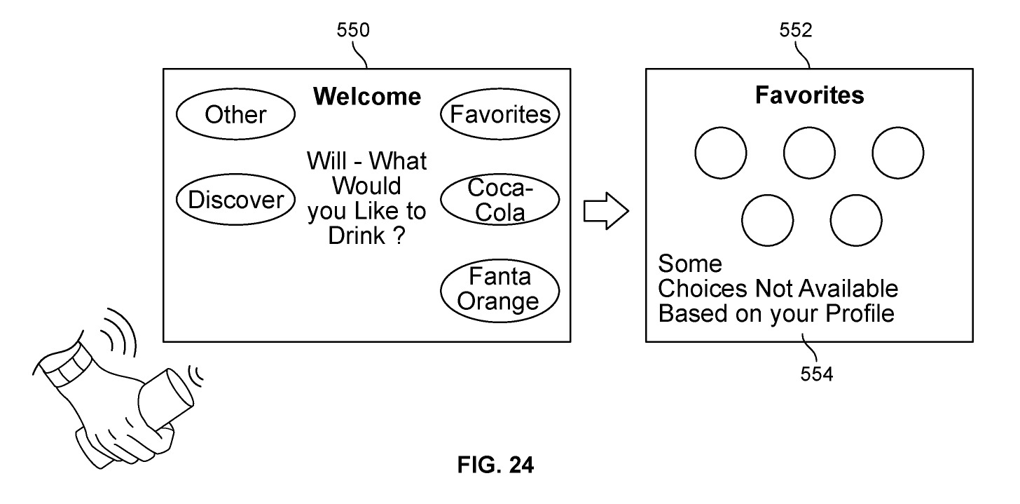

Referring now to FIG. 24, various additional user interface screens for the dispensing device 520 are shown. At a user interface 550, the customer is presented with several options for the dispensing of a beverage. When the customer selects a “favorites” option, a user interface 552 is shown that provides the customer with favorite beverages that the customer 502 has previously identified and/or beverages that have been pre-selected for the customer based upon prior selections or preferences.

The user interface 552 includes a message 554 indicating that certain favorite selections are not available based upon certain preferences defined in the customer's profile. These favorites are depicted as being greyed out on the user interface 552 and cannot be selected by the customer 502.

The unavailable selections can be identified by the dispensing device 520 based upon various criteria. For example, the customer's profile can define certain beverage intake requirements (e.g., limits on such aspects as amount of caffeine, caloric consumption, etc.). The dispensing device 520 considers the customer's profile and presents beverage options that are consistent with those preferences.

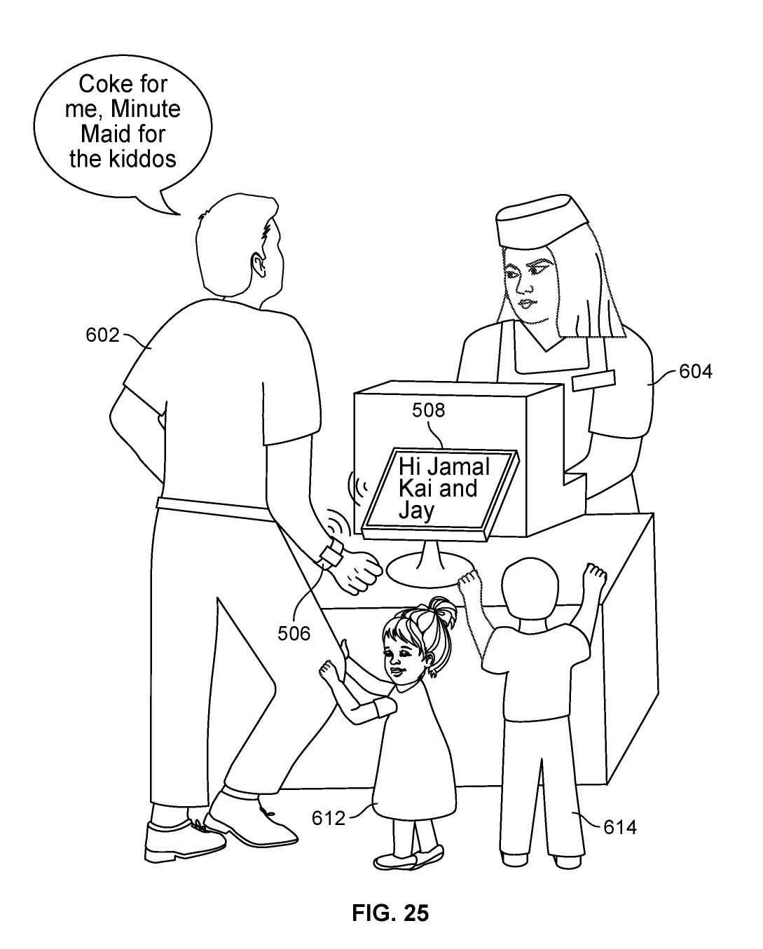

Referring now to FIG. 25, in this example multiple customers 602, 612, 614 are interacting with a service provider 604 to order beverages. As the customer 602 orders the beverages, the customer's profile can be accessed as provided above. In addition, the customer's profile can include sub-profiles for the customers 612, 614 so that each customer's preferences are addressed during ordering of the beverages. In other examples, the profiles can be linked so that once a single customer is authenticated, the preferences from multiple linked profiles can be accessed. Other configurations are possible.

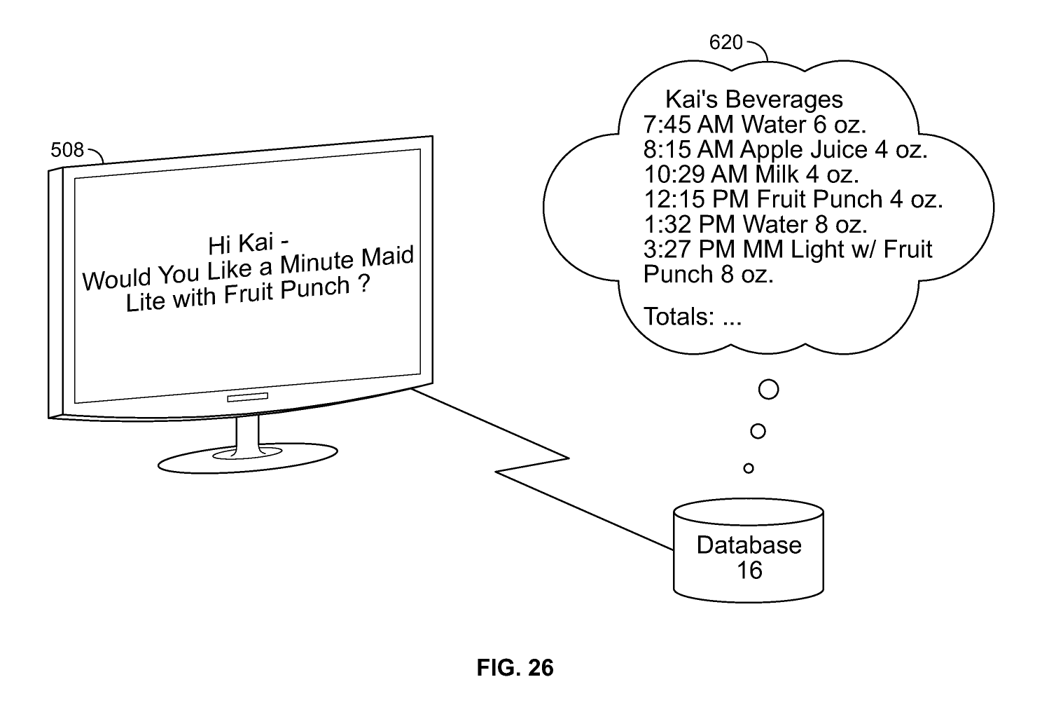

Referring now to FIG. 26, in this example, the customer's preferences and beverage history 620 are accessed from the database 16. Based upon these preferences and history, the interactive display 508 provides certain beverage suggestions to the customer, either proactively as the customer is identified or upon request from the customer. In this example, the interactive display 508 suggests a certain beverage on the interactive display 508 based upon the beverage history 620 for the customer for that day. The suggestions can be made based upon certain preferences that are defined by the customer in the customer's profile and/or based upon other criteria defined, for example, for a certain demography.

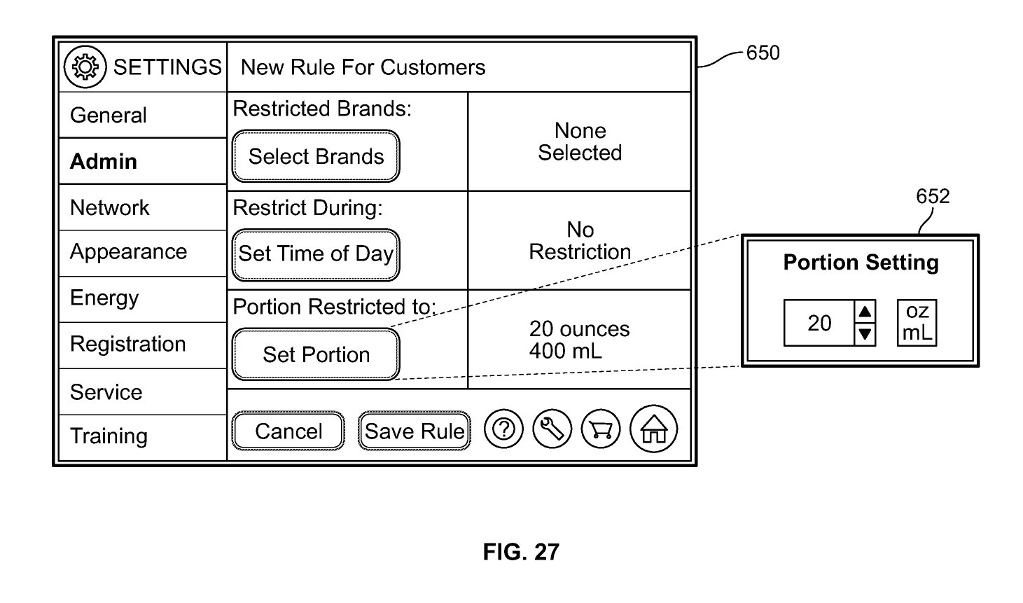

Referring now to FIGS. 27-30, an example embodiment is shown that provides limits on beverage dispensing in a self-serve environment, similar to that described above with reference to FIGS. 13-15. In this example, various criteria can be defined on a user interface 650 at the POS and/or dispenser by the retail manager and/or other service provider. The criteria can include certain restrictions (e.g., on brands, time of day, portion control, etc.) and can be applied to a certain customer base and/or all customers at a given location. In this example, a control 652 on the user interface 650 allows the retail manager and/or other service provider to define a maximum portion for dispensing of a beverage to a customer.

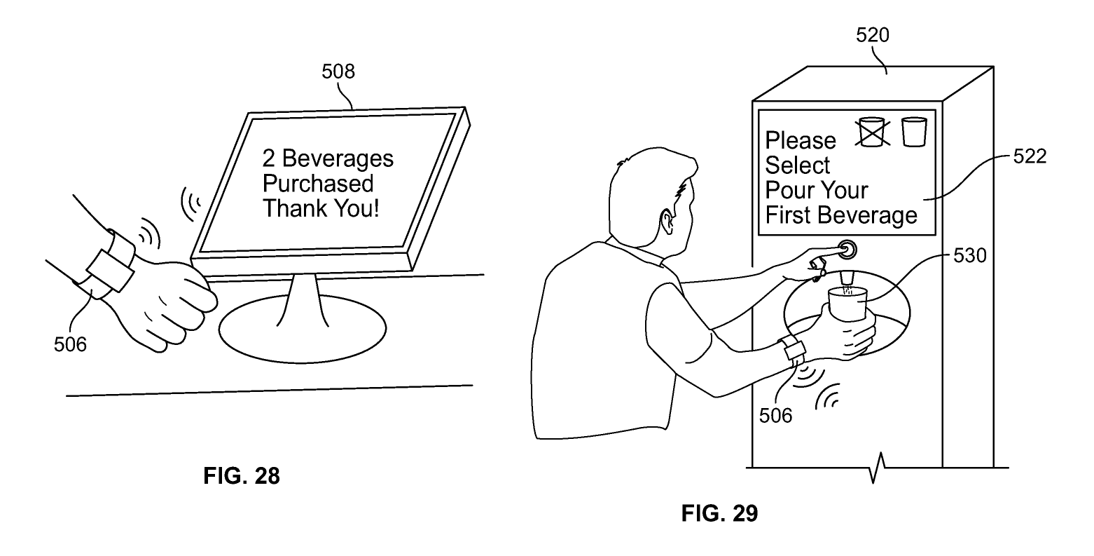

As shown in FIG. 28, the customer purchases two beverages, and the purchase is communicated wirelessly to the customer's smartwatch 506. In FIG. 29, as the customer approaches the dispensing device 520, the smartwatch 506 communicates with the dispensing device 520 to authorize the pour of the beverage. In this example, the display 522 of the dispensing device 520 indicates that the customer has just dispensed a first beverage.

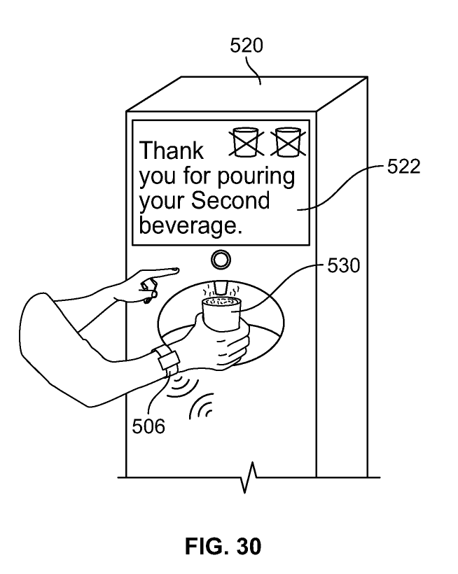

As shown in FIG. 30, once the customer dispenses the second beverage, the display 522 indicates the same, and the dispensing device 520 does not allow for further dispensing until the customer purchases additional beverages and/or until a particular criteria (e.g., limiting an amount of beverage consumption) is satisfied. Other configurations are possible.

Various embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A beverage dispenser system, comprising:
a beverage dispensing device including a processor and a memory accessible to the processor, the memory storing instructions that when executed by the processor implement a method comprising:
receiving a beverage selection;
comparing the beverage selection to predefined controls; and
dispensing the selected beverage in response to the comparison.

2. The system of claim 1, wherein the implemented method further comprises identifying a user of the beverage machine.

3. The system of claim 1, wherein the predefined controls are stored in the memory.

4. The system of claim 1, wherein the implemented method further comprises generating a user interface, and wherein the beverage selection is received via the user interface.

5. The system of claim 4, wherein the implemented method further comprises defining the controls via the user interface.

6. The system of claim 1, wherein a profile associated with the identified user is stored in the memory, the profile including the predefined controls.

7. The system of claim 6, wherein a plurality of the profiles for a corresponding plurality of users are stored in the memory.

8. The system of claim 1, further comprising an external computing device connectable to the beverage dispensing device, wherein the beverage selection is received via a user interface generated by the external computing device.

9. The system of claim 8, wherein the external computing device is connectable to the beverage dispensing device via a wireless connection.

10. The system of claim 1, further comprising an external computing device, wherein the predefined controls are stored in a database on a memory of the external computing device.

11. A method of dispensing a beverage from a beverage dispensing device, comprising:
receiving a beverage selection by a computing device;
comparing the beverage selection to predefined controls; and
dispensing the selected beverage in response to the comparison.

12. The method of claim 11, further comprising identifying a user of the beverage machine by the computing device.

13. The method of claim 12, further comprising retrieving a profile associated with the identified user from a database by the computing device, the profile including the predefined controls.

14. The method of claim 12, wherein identifying the user includes receiving a personal identification number (PIN) or biometric identifier.

15. The method of claim 11, wherein the beverage selection is received via a user interface.

16. The method of claim 13, further comprising creating the profile via a user interface.

17. The method of claim 13, further comprising creating a plurality of profiles for a corresponding plurality of users.

18. The method of claim 16, wherein the beverage dispensing device includes the computing device that generates the user interface.

19. The method of claim 16, wherein the user interface is generated by a computing device remote from the beverage dispensing device.

20. The method of claim 11, further comprising:
displaying a menu of approved beverages on the user interface based on the predefined controls.

21. The method of claim 15, further comprising:
displaying a menu of approved beverages on the user interface based on the retrieved profile.

22. The method of claim 11, further comprising:
sending the beverage selection from a customer application implemented on a computing device remote from the beverage dispensing device to a point of sale (POS) system; and
storing the beverage selection in a database.

23. The method of claim 22, further comprising retrieving the beverage selection from the database by the dispensing device.
